(19) United States
(12) Patent Application Publication
(10) Pub. No.: US 2022/0275589 A1
(43) Pub. Date: Sep. 1, 2022

(54) PAVEMENT LAYING METHOD AND POLYURETHANE PAVEMENT COATING

(71) Applicant: NAN YA PLASTICS CORPORATION, TAIPEI (TW)

(72) Inventors: TE-CHAO LIAO, TAIPEI (TW); SEN-HUANG HSU, TAIPEI (TW); YU-LIN LI, Taoyuan City (TW)

(21) Appl. No.: 17/474,119

(22) Filed: Sep. 14, 2021

(30) Foreign Application Priority Data
Feb. 26, 2021 (TW) 110106917

(51) Int. Cl. E01C 7/35; C08G 18/76; C08G 18/42; C08K 11/00; C09D 175/06; C04B 41/00; C04B 41/48; C04B 41/63

(52) U.S. Cl. CPC E01C 7/356; C08G 18/7671; C08G 18/4288; C08K 11/00; C09D 175/06; C04B 41/009; C04B 41/4884; C04B 41/63

(57) ABSTRACT

A pavement laying method and a polyurethane pavement coating are provided. The pavement laying method includes: providing a solid particle material; mixing a polyester polyol material and an isocyanate material into the solid particle material to form a mixed slurry; and laying the mixed slurry onto a pavement and solidifying the mixed slurry, so as to form a polyurethane pavement coating on the pavement. In addition, at least one of the polyester polyol material and the isocyanate material is derived from biomass resources.

### CROSS-REFERENCE TO RELATED PATENT APPLICATION

This application claims the benefit of priority to Taiwan Patent Application No. 110106917, filed on Feb. 26, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a pavement laying method, and more particularly to a pavement laying method and a polyurethane pavement coating that can achieve an effect of environmental protection.

### BACKGROUND OF THE DISCLOSURE

Conventionally, synthetic auxiliaries need to be added to an adhesive in manufacturing of a pavement coating (otherwise referred to as a permeable pavement). In addition, the source of materials for conventional adhesives mostly comes from nonrenewable raw materials (e.g., a petrochemical raw material), which are not eco-friendly, and are harmful to human health.

### SUMMARY OF THE DISCLOSURE

In response to the above-referenced technical inadequacies, the present disclosure provides a pavement laying method and a polyurethane pavement coating.

In one aspect, the present disclosure provides a pavement laying method. The pavement laying method includes: providing a solid particle material; mixing a polyester polyol material and an isocyanate material into the solid particle material to form a mixed slurry, in which at least one of the polyester polyol material and the isocyanate material is derived from biomass resources; and laying the mixed slurry onto a pavement and solidifying the mixed slurry, so as to form a polyurethane pavement coating on the pavement.

In certain embodiments, the polyester polyol material is a polyester polyol including a plurality of functional groups, and a functionality of the polyester polyol material is within a range from 2.5 to 3.0. The isocyanate material is an isocyanate including a plurality of functional groups, and a functionality of the isocyanate material is within a range from 2.5 to 3.0.

In certain embodiments, the polyester polyol material is a biomass polyester polyol, and the polyester polyol material is castor oil or a derivative of castor oil.

In certain embodiments, the polyester polyol material is pure castor oil, and the polyester polyol material does not include any other polyester polyols.

In certain embodiments, a weight ratio between the polyester polyol material and the isocyanate material is within a range from 1:0.5 to 1:0.9. A sum of weights of the polyester polyol material and the isocyanate material is within a range from 1 wt % to 5 wt % based on a total weight of the solid particle material.

In certain embodiments, after laying the mixed slurry onto the pavement, the polyester polyol material and the isocyanate material undergo a cross-linking reaction to solidify the mixed slurry. Under a temperature between 15° C. and 40° C., a viscosity of the mixed slurry is within a range from 20,000 to 30,000 in a first hour of the cross-linking reaction, and the viscosity of the mixed slurry is within a range from 30,000 to 300,000 during the first hour of the cross-linking reaction to a sixth hour of the cross-linking reaction.

In certain embodiments, after a solidification period of 6 hours, the mixed slurry is configured to completely solidify and form into the polyurethane pavement coating.

In certain embodiments, the mixed slurry does not include any polyurethane synthetic auxiliary, the polyurethane synthetic auxiliary being at least one of a catalyst, a polymerization inhibitor, a chain extender, and a cross-linking agent.

In another aspect, the present disclosure provides a polyurethane pavement coating suitable for being laid onto a pavement. The polyurethane pavement coating includes a solid particle material and a polyurethane adhesive glue. The polyurethane adhesive glue is adhered among a plurality of solid particles of the solid particle material. The polyurethane adhesive glue is formed by a cross-linking reaction between a polyester polyol material and an isocyanate material and solidification of the polyester polyol material and the isocyanate material. At least one of the polyester polyol material and the isocyanate material is derived from biomass resources.

In certain embodiments, the polyester polyol material is a polyester polyol including a plurality of functional groups, and a functionality of the polyester polyol material is within a range from 2.5 to 3.0. The isocyanate material is an isocyanate including a plurality of functional groups, and a functionality of the isocyanate material is within a range from 2.5 to 3.0.

In certain embodiments, the polyester polyol material is a biomass polyester polyol, and the polyester polyol material is castor oil. The polyester polyol material is pure castor oil, and the polyester polyol material does not include any other polyester polyols.

In certain embodiments, a weight ratio between the polyester polyol material and the isocyanate material is within a range from 1:0.5 to 1:0.9. A sum of weights of the polyester polyol material and the isocyanate material is within a range from 1 wt % to 5 wt % based on a total weight of the solid particle material.

In certain embodiments, the polyurethane pavement coating does not include any polyurethane synthetic auxiliary, the polyurethane synthetic auxiliary being at least one of a catalyst, a polymerization inhibitor, a chain extender, and a cross-linking agent.

Therefore, in the pavement laying method and the polyurethane pavement coating provided by the present disclosure, by virtue of “mixing the polyester polyol material and the isocyanate material into the solid particle material to form a mixed slurry, in which at least one of the polyester polyol material and the isocyanate material is derived from biomass resources” and “laying the mixed slurry onto the pavement and solidifying the mixed slurry so as to form the polyurethane pavement coating on the pavement,” a finally-formed pavement coating can achieve an effect of environmental protection, and reduce harm to human health.

Furthermore, without adding any additional synthetic auxiliary, the polyurethane pavement coating of the present embodiment can have outstanding constructability, outstanding permeability, and outstanding physicochemical properties (e.g., mechanical strength).

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a pavement laying method according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

Conventionally, synthetic auxiliaries need to be added to an adhesive in manufacturing of a pavement coating (otherwise referred to as a permeable pavement). In addition, the source of materials for conventional adhesives mostly comes from nonrenewable raw materials (e.g., a petrochemical raw material), which are not eco-friendly, and are harmful to human health.

In order to overcome the above-mentioned technical inadequacies, an objective of the present disclosure is to use a two-component polyurethane adhesive for manufacturing a pavement coating. The polyurethane adhesive includes materials derived from biomass resources, and no additional synthetic auxiliary needs to be added to the polyurethane adhesive.

Accordingly, a finally-formed pavement coating of the present disclosure can achieve an effect of environmental protection, and reduce harm to human health. Further, the finally-formed pavement coating is better than a conventional pavement coating in terms of permeability and physical properties (e.g., mechanical strength).

### Pavement Laying Method

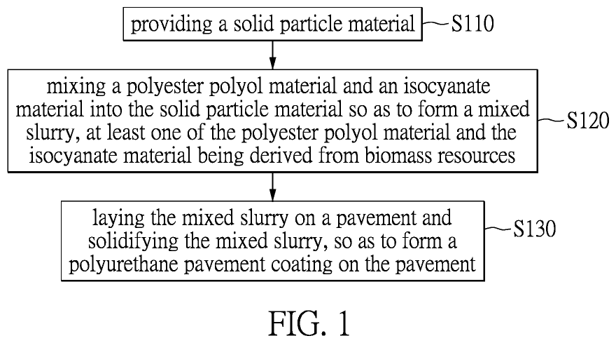

Referring to FIG. 1, FIG. 1 is a flowchart of a pavement laying method according to an embodiment of the present disclosure. In order to achieve the above-mentioned objective, the pavement laying method provided in the embodiment of the present disclosure includes a step S110, a step S120, and a step S130. It should be noted that an order of each step and an actual operation recited herein can be adjusted according to practical requirements, and are not limited by the present embodiment.

In the step S110, a solid particle material is provided.

The solid particle material is suitable for pavement laying. For example, the solid particle is at least one of a gravel particle material, a plastic particle material, a rubber particle material, a concrete particle material, a metal particle material, and a glass particle material. In the present embodiment, the solid particle material is the gravel particle material, but the present disclosure is not limited thereto.

Further, a certain amount of the solid particle material can be weighed, for example, according to a construction requirement of the pavement laying. Then, according to the construction requirement, a certain amount of the two-component polyurethane adhesive is weighed and added to the solid particle material. Furthermore, a particle size range of the solid particle material can be selected according to the construction requirement, and the present disclosure is not limited thereto. A detailed preparation method is described in the following steps.

In the step S120, a polyester polyol material and an isocyanate material are mixed into the solid particle material, so as to form a mixed slurry. At least one of the polyester polyol material and the isocyanate material is derived from biomass resources.

In other words, the mixed slurry includes the solid particle material, the polyester polyol material, and the isocyanate material, which are all mixed with each other. After the polyester polyol material and the isocyanate material are mixed with each other, the two-component polyurethane adhesive (otherwise referred to as a urethane prepolymer) can be formed. Then, the two-component polyurethane adhesive begins to undergo a cross-linking reaction, so that the mixed slurry solidifies and forms into a solid polyurethane pavement coating.

At least one of the polyester polyol material and the isocyanate material is derived from the biomass resources, so that the finally-formed pavement coating of the present disclosure can achieve an effect of environmental protection and reduce harm to human health.

In one embodiment of the present disclosure, the polyester polyol material is a polyester polyol having a plurality of functional groups, and a functionality of the polyester polyol material is preferably within a range from 2.5 to 3.0. More preferably, the functionality of the polyester polyol material is within a range from 2.6 to 2.8. Further, the isocyanate material is an isocyanate having a plurality of functional groups, and a functionality of the isocyanate material is preferably within a range from 2.5 to 3.0. More preferably, the functionality of the isocyanate material is within a range from 2.6 to 2.8. Accordingly, a cross-linking degree of the polyester polyol material and the isocyanate material can be higher, so as to elevate mechanical strength of the finally-formed polyurethane pavement coating.

In one embodiment of the present disclosure, the polyester polyol material is a biomass polyester polyol, and the polyester polyol material is castor oil or a derivative of castor oil.

Specifically, of all vegetable oils, the castor oil selected in the present embodiment is the only vegetable oil that has hydroxyl groups. An average functionality of the hydroxyl groups of the castor oil is usually within a range from 2.5 to 3.0, and is preferably within a range from 2.6 to 2.8. The castor oil has an iodine value within a range from 80 mg to 90 mg, a saponification value within a range from 170 mgKOH/g to 190 mgKOH/g, and a hydroxyl value within a range from 155 mgKOH/g to 165 mgKOH/g.

According to the physicochemical properties of castor oil, the hydroxyl group (—OH) of the castor oil is suitable for reacting with an isocyanate group (—NCO) of the isocyanate, so as to form the urethane prepolymer (i.e., the polyurethane adhesive). Accordingly, the polyester polyol derived from the biomass resources can be introduced into a composition of the urethane prepolymer, so that the finally-formed pavement coating can achieve the effect of environmental protection.

Furthermore, since the average functionality of the hydroxyl groups of the castor oil is normally within a range from 2.5 to 3.0 (which is quite high), there is a high cross-linking degree in the cross-linking reaction between the castor oil and the isocyanate having a plurality of functional groups. Accordingly, the mechanical strength of the finally-formed polyurethane pavement coating can be effectively elevated.

In one embodiment of the present disclosure, the polyester polyol material is pure castor oil, and the polyester polyol material does not include any other polyester polyols. Further, the polyurethane adhesive does not include any other oil material that is different from the castor oil (e.g., coconut oil, olive oil, etc.), either. In other words, a composition of the polyester polyol material is completely castor oil.

Through experiments, it has been observed that compared to a polyurethane adhesive mixed with other polyester polyol materials or oil materials, the polyester polyol material and the isocyanate material have a faster reaction rate when the polyester polyol material is pure castor oil, and the finally-formed polyurethane pavement coating has a stronger mechanical strength.

In one embodiment of the present disclosure, the isocyanate material can be, for example, a biomass diisocyanate (e.g., a biomass MDI). Accordingly, the content of biomass materials of the polyurethane adhesive can be obviously elevated, so that the finally-formed pavement coating can better achieve the effect of environmental protection, but the present disclosure is not limited thereto. For example, the isocyanate material can be an isocyanate derived from petrochemical sources. Furthermore, in another embodiment of the present disclosure, the isocyanate material can be, for example, a diisocyanate having a plurality of functional groups (e.g., a PMDI), so as to effectively elevate the cross-linking degree of the cross-linking reaction.

In the step S130, the mixed slurry is laid onto a pavement and the mixed sluny is solidified, so as to form a polyurethane pavement coating on the pavement.

In the mixed slurry, a weight ratio between the polyester polyol material and the isocyanate material is preferably within a range from 1:0.5 to 1:0.9. Further, a sum of weights of the polyester polyol material and the isocyanate material is preferably within a range from 1 wt % to 5 wt % based on a total weight of the solid particle material, and is more preferably within a range from 3 wt % to 5 wt % based on the total weight of the solid particle material.

When implemented in construction, the polyester polyol material and the isocyanate material can each be added to a weighed solid particle material according to the above-mentioned range of the weight ratio, so as to form the mixed slurry. Alternatively, the polyester polyol material and the isocyanate material can be mixed with each other according to the above-mentioned range of the weight ratio and then be added to the weighed solid particle material in a very short time (e.g., less than 1 minute), and a surface of the solid particle material is fully humidified, so as to form the mixed slurry. Finally, the mixed sluny is laid onto the pavement, so as to form the polyurethane pavement coating on the pavement.

Further, after the mixed slurry is laid onto the pavement, the polyester polyol material and the isocyanate material undergo the cross-linking reaction to solidify the mixed slurry.

According to a configuration of the mixed slurry, the polyester polyol material and the isocyanate material can have a slower initial reaction rate, so that a pavement construction time can be extended.

Specifically, under a temperature between 15° C. and 40° C., a viscosity of the mixed slurry is within a range from 20,000 to 30,000 in a first hour of the cross-linking reaction, and the viscosity of the mixed slurry is within a range from 30,000 to 300,000 during the first hour of the cross-linking reaction to a sixth hour of the cross-linking reaction.

Further, after a solidification period of 6 hours, the mixed slurry is configured to completely solidify and form into the polyurethane pavement coating.

Furthermore, the mixed slurry can be configured to not include any polyurethane synthetic auxiliary. The polyurethane synthetic auxiliary is at least one of a catalyst, a polymerization inhibitor, a chain extender, and a cross-linking agent.

### Polyurethane Pavement Coating

The above is a description of the pavement laying method of the embodiment of the present disclosure, and the polyurethane pavement coating of the embodiment of the present disclosure will be introduced as follows. In the present embodiment, the polyurethane pavement coating is formed by the above-mentioned pavement laying method, but the present disclosure is not limited thereto.

The polyurethane pavement coating is suitable for being laid on a pavement, and the polyurethane pavement coating includes a solid particle material and a polyurethane adhesive glue.

The polyurethane adhesive glue is adhered among a plurality of solid particles of the solid particle material. The polyurethane adhesive glue is formed by a cross-linking reaction between a polyester polyol material and an isocyanate material and solidification of the polyester polyol material and the isocyanate material. In addition, at least one of the polyester polyol material and the isocyanate material is derived from biomass resources.

In one embodiment of the present disclosure, the polyester polyol material is a polyester polyol including a plurality of functional groups, and a functionality of the polyester polyol material is within a range from 2.5 to 3.0. Further, the isocyanate material is an isocyanate including a plurality of functional groups, and a functionality of the isocyanate material is within a range from 2.5 to 3.0

In one embodiment of the present disclosure, the polyester polyol material is a biomass polyester polyol, and the polyester polyol material is castor oil. Further, the polyester polyol material is pure castor oil, and the polyester polyol material does not include any other polyester polyols.

In one embodiment of the present disclosure, a weight ratio between the polyester polyol material and the isocyanate material is within a range from 1:0.5 to 1:0.9. Further, a sum of weights of the polyester polyol material and the isocyanate material is within a range from 1 wt % to 5 wt % based on a total weight of the solid particle material.

In one embodiment of the present disclosure, the polyurethane pavement coating does not include any polyurethane synthetic auxiliary. The polyurethane synthetic auxiliary is at least one of a catalyst, a polymerization inhibitor, a chain extender, and a cross-linking agent.

### Experimental Data Test

Hereinafter, exemplary examples 1 to 4 will be described in detail. However, these exemplary examples are provided merely to aid understanding of the present disclosure, and the scope of the present disclosure is not limited thereby.

The exemplary example 1 includes: mixing the polyester polyol (castor oil) and the isocyanate (PMDI) in a ratio of 1:0.85 (2.7:2.3), so as to form a pre-reaction mixture; mixing the pre-reaction mixture and gravel particles in a ratio of 5:100, so as to form a reaction mixture; and using the reaction mixture to manufacture a 3-cm stone for subsequent physical tests.

The exemplary example 2 includes: mixing the polyester polyol (castor oil) and the isocyanate (PMDI) in a ratio of 1:0.85 (2.2:1.8), so as to form a pre-reaction mixture; mixing the pre-reaction mixture and gravel particles in a ratio of 4:100, so as to form a reaction mixture; and using the reaction mixture to manufacture a 3-cm stone for the subsequent physical tests.

The exemplary example 3 includes: mixing the polyester polyol (castor oil) and the isocyanate (PMDI) in a ratio of 1:0.85 (1.6:1.4), so as to form a pre-reaction mixture; mixing the pre-reaction mixture and gravel particles in a ratio of 3:100, so as to form a reaction mixture; and using the reaction mixture to manufacture a 3-cm stone for the subsequent physical tests.

The exemplary example 4 includes: mixing the polyester polyol (castor oil) and the isocyanate (PMDI) in a ratio of 1:0.65 (2.4:1.6), so as to form a pre-reaction mixture; mixing the pre-reaction mixture and gravel particles in a ratio of 4:100, so as to form a reaction mixture; and using the reaction mixture to manufacture a 3-cm stone for the subsequent physical tests.

Preparation parameters of each component are summarized in Table 1 as shown below.

Afterwards, tests of physicochemical properties are performed on the polyurethane pavement coatings (stones) made from the exemplary examples 1 to 4, so as to acquire the physicochemical properties of the polyurethane pavement coatings, such as mechanical strength, weather resistance, and permeability. Related testing methods in connection with the following properties are described below, and relevant test results are summarized in Table 1.

Mechanical strength: performing a compression strength test on the stone.

Weather resistance: placing the stone in a testing machine having a high temperature and a high humidity (i.e., a temperature of 85° C. and a humidity of 85%), and then taking out the stone two months later for testing.

Permeability: performing a permeability test according to local CNS 14995 standards.

Table 1 shows the content of each component and the test results of the exemplary examples.

| | | Exemplary | Exemplary | Exemplary | Exemplary |
|---|---|---|---|---|---|
| Items | | example 1 | example 2 | example 3 | example 4 |
| Polyurethane | Solid particle | 100 | 100 | 100 | 100 |
| Pavement | material | | | | |
| Coating | (weight ratio) | | | | |
| | Polyester polyol | 2.7 | 2.2 | 1.6 | 2.4 |
| | (weight ratio) | | | | |
| | Isocyanate | 2.3 | 1.8 | 1.4 | 1.6 |
| | (weight ratio) | | | | |
| Test results | Mechanical | Maximum | Maximum | Maximum | Maximum |
| | strength | load | load | load | load |
| | | 5-6 N/mm² | 5-6 N/mm² | 5-6 N/mm² | 2-3 N/mm² |
| | Weather | No change in | No change in | No change in | No change in |
| | resistance | mechanical | mechanical | mechanical | mechanical |
| | | strength | strength | strength | strength |
| | Permeability | Greater | Greater | Greater | Greater |
| | | than 90% | than 90% | than 90% | than 90% |

### Discussion of Test Results

According to the experimental data of Table 1, each stone of the exemplary examples 1 to 4 has outstanding mechanical strength (i.e., maximum load 2-6 N/mm²), outstanding weather resistance, and outstanding permeability (i.e., greater than 90%).

Furthermore, according to the experimental data of Table 1, each stone of the exemplary examples 1 to 3 has stronger mechanical strength (i.e., maximum load 5-6 N/mm²) than the stone of the exemplary example 4 because each stone of the exemplary examples 1 to 3 has a higher weight ratio of isocyanate than the stone of the exemplary example 4.

### Beneficial Effects of the Embodiments

In conclusion, in the pavement laying method and the polyurethane pavement coating provided by the present disclosure, by virtue of “mixing the polyester polyol material and the isocyanate material into the solid particle material to form a mixed slurry, in which at least one of the polyester polyol material and the isocyanate material is derived from biomass resources” and “laying the mixed slurry onto the pavement and solidifying the mixed slurry, so as to form the polyurethane pavement coating on the pavement”, a finally-formed pavement coating can achieve the effect of environmental protection, and reduce harm to human health.

Furthermore, without adding any additional synthetic auxiliary, the polyurethane pavement coating of the present embodiment can have outstanding constructability, outstanding permeability, and outstanding physicochemical properties (e.g., mechanical strength).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pavement laying method, comprising:
providing a solid particle material;
mixing a polyester polyol material and an isocyanate material into the solid particle material to form a mixed slurry, wherein at least one of the polyester polyol material and the isocyanate material is derived from biomass resources; and
laying the mixed slurry onto a pavement and solidifying the mixed slurry, so as to form a polyurethane pavement coating on the pavement.

2. The pavement laying method according to claim 1, wherein the polyester polyol material is a polyester polyol including a plurality of functional groups, and a functionality of the polyester polyol material is within a range from 2.5 to 3.0, and wherein the isocyanate material is an isocyanate including a plurality of functional groups, and a functionality of the isocyanate material is within a range from 2.5 to 3.0.

3. The pavement laying method according to claim 2, wherein the polyester polyol material is a biomass polyester polyol, and the polyester polyol material is castor oil or a derivative of castor oil.

4. The pavement laying method according to claim 3, wherein the polyester polyol material is pure castor oil, and the polyester polyol material does not include any other polyester polyols.

5. The pavement laying method according to claim 4, wherein a weight ratio between the polyester polyol material and the isocyanate material is within a range from 1:0.5 to 1:0.9, and wherein a sum of weights of the polyester polyol material and the isocyanate material is within a range from 1 wt % to 5 wt % based on a total weight of the solid particle material.

6. The pavement laying method according to claim 5, wherein, after laying the mixed slurry onto the pavement, the polyester polyol material and the isocyanate material undergo a cross-linking reaction to solidify the mixed slurry, and wherein, under a temperature between 15° C. and 40° C., a viscosity of the mixed slurry is within a range from 20,000 to 30,000 in a first hour of the cross-linking reaction, and the viscosity of the mixed slurry is within a range from 30,000 to 300,000 during the first hour of the cross-linking reaction to a sixth hour of the cross-linking reaction.

7. The pavement laying method according to claim 6, wherein, after a solidification period of 6 hours, the mixed slurry is configured to completely solidify and form into the polyurethane pavement coating.

8. The pavement laying method according to claim 5, wherein the mixed slurry does not include any polyurethane synthetic auxiliary, the polyurethane synthetic auxiliary being at least one of a catalyst, a polymerization inhibitor, a chain extender, and a cross-linking agent.

9. A polyurethane pavement coating suitable for being laid onto a pavement, comprising:
a solid particle material; and
a polyurethane adhesive glue adhered among a plurality of solid particles of the solid particle material, wherein the polyurethane adhesive glue is formed by a cross-linking reaction between a polyester polyol material and an isocyanate material and solidification of the polyester polyol material and the isocyanate material, and wherein at least one of the polyester polyol material and the isocyanate material is derived from biomass resources.

10. The polyurethane pavement coating according to claim 9, wherein the polyester polyol material is a polyester polyol including a plurality of functional groups, and a functionality of the polyester polyol material is within a range from 2.5 to 3.0, and wherein the isocyanate material is an isocyanate including a plurality of functional groups, and a functionality of the isocyanate material is within a range from 2.5 to 3.0.

11. The polyurethane pavement coating according to claim 10, wherein the polyester polyol material is a biomass polyester polyol, and the polyester polyol material is castor oil, and wherein the polyester polyol material is pure castor oil, and the polyester polyol material does not include any other polyester polyols.

12. The polyurethane pavement coating according to claim 11, wherein a weight ratio between the polyester polyol material and the isocyanate material is within a range from 1:0.5 to 1:0.9, and wherein a sum of weights of the polyester polyol material and the isocyanate material is within a range from 1 wt % to 5 wt % based on a total weight of the solid particle material.

13. The polyurethane pavement coating according to claim 12, wherein the polyurethane pavement coating does not include any polyurethane synthetic auxiliary, the polyurethane synthetic auxiliary being at least one of a catalyst, a polymerization inhibitor, a chain extender, and a cross-linking agent.
